(19) United States
(12) Patent Application Publication
(10) Pub. No.: US 2024/0334309 A1
(43) Pub. Date: Oct. 3, 2024

(54) METHOD AND APPARATUS TO BLOCK CONTROL PLANE DATA FOR PARTIALLY ALLOWED NSSAI AND NS-AOS IN A WIRELESS COMMUNICATION SYSTEM

(71) Applicant: Samsung Electronics Co., Ltd., Gyeonggi-do (KR)

(72) Inventors: Lalith KUMAR, Bangalore (IN); Danish Ehsan Hashmi, Bangalore (IN); Jagadeesh Gandikota, Bangalore (IN); Krishnamurthy D R, Bangalore (IN); Ashok Kumar Nayak, Bangalore (IN); Koustav Roy, Bangalore (IN)

(21) Appl. No.: 18/621,733

(22) Filed: Mar. 29, 2024

(30) Foreign Application Priority Data
Mar. 30, 2023 (IN) 202341024291
Mar. 17, 2024 (IN) 202341024291

(51) Int. Cl. H04W 48/04

(52) U.S. Cl. CPC H04W 48/04

(57) ABSTRACT

The disclosure relates to a 5G or 6G communication system for supporting a higher data transmission rate. Methods and systems are provided in which control plane data is blocked for partially allowed network slice selection assistance information (NSSAI) and network slice area of service (NS-AoS) when a user equipment (UE) is in an area/cell/tracking area (TA) where the S-NSSAI is not available/supported. The UE initiates the NAS transport procedure for a cellular Internet of things (CIOT) user data container when the UE is in an area/cell/TA where the S-NSSAI is not available/supported of NS-AOS area. The UE initiates the NAS transport procedure for the CIOT user data container when the UE is in an area/cell/TA where the S-NSSAI is not available/supported of S-NSSAI supported area.

### CROSS REFERENCE TO RELATED APPLICATION

This application claims priority under 35 U.S.C. 119 (a) to Indian Provisional Application No. 20/234,1024291, filed in the Indian Patent Office on Mar. 30, 2023, and Indian Non-Provisional application Ser. No. 20/234,1024291, filed in the Indian Patent Office on Mar. 17, 2024, the contents of which are incorporated herein by reference.

### BACKGROUND

### 1. Field of the Invention

Embodiments disclosed herein relate generally to wireless communication networks, and more particularly, to block control plane data for partially allowed network slice selection assistance information (NSSAI) and network slice area of service (NS-AoS) when a user equipment (UE) is in an area, cell, or/tracking area (TA) where a single-NSSAI (S-NSSAI) (e.g., S-NSSAI-A) is not available or supported.

### 2. Description of Related Art

5G mobile communication technologies define broad frequency bands such that high transmission rates and new services are possible, and can be implemented not only in “Sub 6GHz” bands such as 3.5GHz, but also in “Above 6GHz” bands referred to as mm Wave including 28GHZ and 39GHz. In addition, it has been considered to implement 6G mobile communication technologies (referred to as Beyond 5G systems) in terahertz bands (for example, 95GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The present invention has been made to address at least the above problems and/or disadvantages and to provide at least the advantages described below. Accordingly, an aspect of the present invention provides systems and methods to block control plane data for partially/partly allowed NSSAI and NS-AoS when a UE is in an area/cell/TA where the S-NSSAI (e.g., S-NSSAI-A) is not available/supported.

Another aspect of the present invention provides systems and methods for managing a NAS transport procedure by a network.

Another aspect of the present invention provides systems and methods for enabling a UE to initiate the NAS transport procedure for a CIoT user data container when UE is in an area/cell/TA where the S-NSSAI (e.g., S-NSSAI-A) is not available/supported of NS-AOS area.

Another aspect of the present invention provides systems and methods for enabling the UE to initiate the NAS transport procedure for the CIoT user data container when the UE is in an area/cell/TA where the S-NSSAI (e.g., S-NSSAI-A) is not available/supported of S-NSSAI supported area.

Accordingly, embodiments provide a method for managing control plane (CP) data for partially allowed NSSAI and a NS-AoS. A UE receives at least one of a partially allowed NSSAI list and NS-AoS information from a network. The partially allowed NSSAI list indicates one or more TAIs where at least one S-NSSAI is supported or not supported, and the NS-AoS information indicates one or more cells where the S-NSSAI is supported or not supported. The UE identifies if a desired S-NSSAI on a current cell and/or a current TAI is supported, based on at least one of the partially allowed NSSAI list and the NS-AoS information. The UE determines whether to initiate an UL NAS message to the network, upon identifying whether the desired S-NSSAI of the current cell or the current TAI is supported, The UL NAS message is used for sending the CP data over the current cell or the current TAI to the network.

Accordingly, embodiments provide a UE that includes a processor and a memory module. The processor is coupled with the memory module. The processor is configured to receive at least one of a partially allowed NSSAI list and NS-AOS information from a network. The partially allowed NSSAI list indicates one or more TAIs where at least one S-NSSAI is supported or not supported, and the NS-AOS information indicates one or more cells where the S-NSSAI is supported or not supported. The processor is configured to identify if a desired S-NSSAI on a current cell and/or a current TAI is supported, based on at least one of the partially allowed NSSAI list and the NS-AoS information. The processor is configured to determine whether to initiate an UL NAS message to the network, upon identifying whether the desired S-NSSAI of the current cell or the current TAI is supported. The UL NAS message is used for sending the CP data over the current cell or the current TAI to the network.

Accordingly, embodiments provide a method for managing the CP data for a partially allowed NSSAI and NS-AoS. The UE receives at least one of a partially allowed NSSAI list and NS-AoS information from a network. The partially allowed NSSAI list indicates one or more TAIs where at least one S-NSSAI is supported or not supported, and the NS-AoS information indicates one or more cells where the S-NSSAI is supported or not supported. The UE identifies if a desired S-NSSAI on a current cell and/or a current TAI is supported, based on at least one of the partially allowed NSSAI list and the NS-AoS information. The UE bars sending of an UL NAS message, upon identifying that the S-NSSAI is not supported/allowed on the current cell or the current TAI, based on at least one of the partially allowed NSSAI list and the NS-AoS information. The UL NAS message is used for sending the CP data over the current cell or the current TAI to the network. The UE receives a reject response from the network indicating that sending of the CP data on the current cell is not allowed, in response to the UL NAS transport message indicating that the UE is on the current cell that does not support the S-NSSAI. The UE terminates sending of the CP data of the current cell on receiving the reject response.

Accordingly, embodiments provide a method for managing a CP data for a partially allowed NSSAI and a NS-AoS. The UE receives at least one of a partially allowed NSSAI list and NS-AoS information from a network. The UE identifies if a desired S-NSSAI on a current cell and/or a current TAI is supported, based on at least one of the partially allowed NSSAI list and the NS-AOS information. The UE initiates an UL NAS message for sending the CP data over the current cell to the network, upon identifying that the S-NSSAI on the current cell is supported, based on the NS-AOS information. The UE initiates the UL NAS message for sending the CP data over the current TAI to the network, upon identifying that the S-NSSAI-A on the current TAI is supported, based on the partially allowed NSSAI list.

Accordingly, embodiments provide a method for managing a CP data for a partially allowed NSSAI and a NS-AoS. A network sends at least one of a partially allowed NSSAI list and

NS-AoS information to a UE. The network bars sending of the CP data of the at least one S-NSSAI to the UE, based on determination from at least one of a partially allowed NSSAI list and NS-AoS information that at least one of a current cell and a current TAI does not support the S-NSSAI. The network receives an UL NAS message from the UE over a current cell and/or a current TAI, upon identifying by the UE if a desired S-NSSAI on the current cell or the current TAI is supported or not supported, based on at least one of the partially allowed NSSAI list and the NS-AoS information. The UL NAS message carries the CP data over the current cell or the current TAI.

Accordingly, embodiments provide a network that includes a processor and a memory module. The processor is coupled with the memory module. The processor is configured to send at least one of a partially allowed NSSAI list and NS-AoS information to a UE. The processor is configured to bar sending of the CP data of the at least one S-NSSAI to the UE, based on determination from at least one of the partially allowed NSSAI list and the NS-AoS information that at least one of a current cell and a current TAI does not support the S-NSSAI. The processor is configured to receive an UL NAS message from the UE over a current cell and/or a current TAI, upon identifying by the UE if a desired S-NSSAI on the current cell or the current TAI is supported or not supported, based on at least one of the partially allowed NSSAI list and the NS-AoS information. The UL NAS message carries the CP data over the current cell or the current TAI.

Accordingly, embodiments provide a method performed by a user equipment (UE) in a wireless communication system, the method comprising: receiving, from an access management function (AMF) entity, a location availability information associated with single-network slice selection assistance information (S-NSSAI) indicating at least one cell of a tracking area (TA) where the S-NSSAI is available; and identifying whether the UE is located in the at least one cell of the TA where the S-NSSAI is available, based on the location availability information associated with the S-NSSAI; in case that the location of the UE is outside of the at least one cell of the TA, determining not to send a non access stratum (NAS) message for a user data.

Accordingly, embodiments provide a method performed by an access management function (AMF) in a wireless communication system, the method comprising: transmitting, to a user equipment (UE), a location information associated with single-network slice selection assistance information (S-NSSAI) indicating at least one cell of a tracking area (TA) including a first cell supporting the S-NSSAI in the TA and a second cell not supporting the S-NSSAI in the TA; wherein a location of the UE is identified, based on the location information associated with the S-NSSAI, and wherein in case that the location of the UE is inside the second cell, not to send a non access stratum (NAS) message for a user data is determined.

Accordingly, embodiments provide a user equipment (UE) in a wireless communication system, the UE comprising: a transceiver; and a controller coupled with the transceiver configured to: receive, from an access management function (AMF) entity, a location information associated with single-network slice selection assistance information (S-NSSAI) indicating at least one cell of a tracking area (TA) including a first cell supporting the S-NSSAI in the TA and a second cell not supporting the S-NSSAI in the TA, identify a location of the UE, based on the location information associated with the S-NSSAI; and in case that the location of the UE is inside the second cell, determine not to send a non access stratum (NAS) message for a user data.

Accordingly, embodiments provide an access management function (AMF) in a wireless communication system, the AMF comprising: a transceiver; and a controller coupled with the transceiver configured to: transmit, to a user equipment (UE), a location information associated with single-network slice selection assistance information (S-NSSAI) indicating at least one cell of a tracking area (TA) including a first cell supporting the S-NSSAI in the TA and a second cell not supporting the S-NSSAI in the TA, wherein a location of the UE is identified, based on the location information associated with the S-NSSAI, and wherein in case that the location of the UE is inside the second cell, not to send a non access stratum (NAS) message for a user data is determined.

### BRIEF DESCRIPTION OF THE DRAWINGS

The above and other objects, features, and advantages of the present invention will be more apparent from the following detailed description when taken in conjunction with the accompanying drawings, in which:

FIG. 1 is a diagram illustrating a method of a UE initiating a NAS transport procedure for a CIoT user data container when the UE in an area (cell/TA) where S-NSSAI is not available/supported;

FIG. 2 is a diagram illustrating a system for managing control plane (CP) data for a partially allowed NSSAI and a NS-AoS, according to an embodiment;

FIG. 3 is a diagram illustrating a plurality of modules of a processor of a UE managing a CP data, according to an embodiment;

FIG. 4 is a diagram illustrating a method for managing the CP data for a partially allowed NSSAI and a NS-AoS, according to an embodiment;

FIG. 5 is a diagram illustrating a method for managing the CP data for a partially allowed NSSAI and a NS-AoS when the S-NSSAI-A of at least one cell is not supported, according to an embodiment;

FIG. 6 is a diagram illustrating a method for managing the CP data for a partially allowed NSSAI and a NS-AoS when the S-NSSAI-A of at least one cell is not supported, according to another embodiment;

FIG. 7 is a diagram illustrating a method for managing the CP data by the network for a partially allowed NSSAI and a NS-AoS, according to an embodiment;

FIG. 8 is a diagram illustrating a message sequence diagram of a network rejecting a UE NAS transport with appropriate reject cause, according to an embodiment;

FIG. 9 is a diagram illustrating a message sequence diagram of a UE not initiating the NAS transport procedure for a CIOT user data container when the UE is in an area/cell/TA where the S-NSSAI is not available/supported according to the NS-AoS area or S-NSSAI location availability information, according to an embodiment; and

FIG. 10 is a diagram illustrating a message sequence diagram where a UE is allowed to initiate the NAS transport procedure for CIOT user data container when a UE is in an area/cell/TA where the S-NSSAI is not available/supported according to NS-AOS area or S-NSSAI location availability information, according to an embodiment.

### DETAILED DESCRIPTION

A partially allowed NSSAI indicates S-NSSAI values that a UE may use in a serving public land mobile network (PLMN) or stand-alone non-public network (SNPN) in some of the TAs in a current registration area. Each S-NSSAI in the partially allowed NSSAI is associated with a list of TAs where the S-NSSAI is supported.

NS-AOS is the area where a UE can access and receive service of a particular network slice as more than zero resources are allocated to the network slice in next generation-radio access network (NG-RAN) cells.

S-NSSAI location availability information that is sent to the UE includes, for each applicable S-NSSAI of the configured NSSAI, location information indicating the cells of TAs in radio access (RA) where the related S-NSSAI is available if the S-NSSAI is not available in all the cells of the TA.

A UE-initiated non-access stratum (NAS) transport procedure includes sending cellular Internet of things (CIoT) user data container. The UE may include a protocol data unit (PDU) session ID, and release assistance indication (if available), set the payload container type information element (IE) to “CIOT user data container”, and set the payload container IE to the user data container.

If an S-NSSAI is in a partially/partly allowed NSSAI list, a UE may not activate a user plane for already established PDU session with that S-NSSAI if the UE is in a cell within the RA but outside the location information of the S-NSSAI. When the UE is in a cell within RA, but outside the location information of the S-NSSAI, it is unclear whether the UE can send the UE initiated NAS transport message to send CIoT user data container, which does not need the user plane resources and what shall be network function (e.g., access and mobility management function (AMF) and session management function (SMF) behavior.

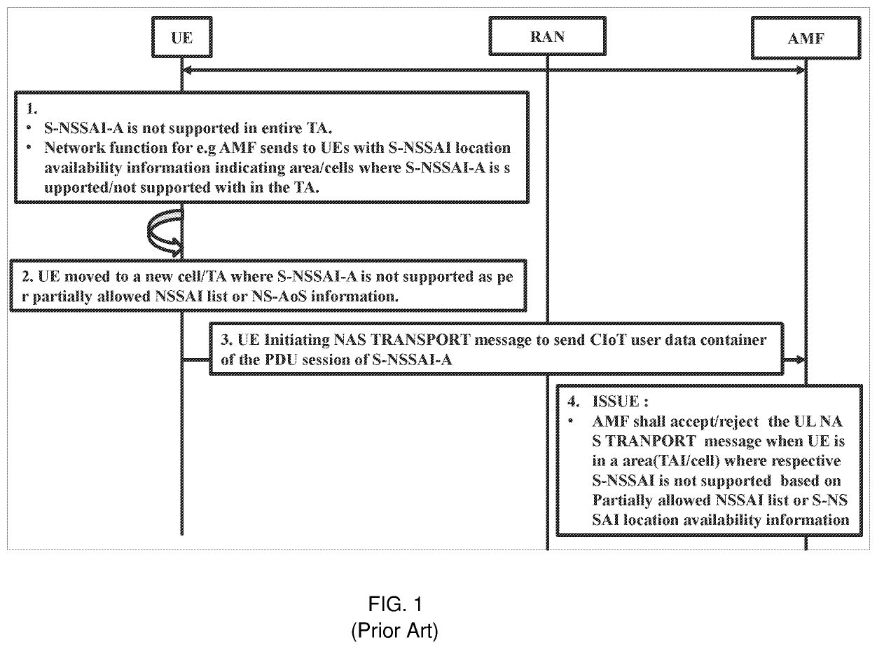

FIG. 1 is a diagram illustrating an existing method of UE initiating a NAS transport procedure for a CIoT user data container when the UE is in an area (Cell/TA) where S-NSSAI is not available/supported. As depicted at step 1, S-NSSAI-A is not supported/allowed in an entire TA or registration area (e.g., a set of TA identities (TAIs)) by a network. A network function, for example, AMF, sends to UEs with S-NSSAI location availability information or partially allowed NSSAI indicating area, cells, or TAIs where S-NSSAI-A is supported/not supported with in the

TA or registration area (e.g., set of TAIs).

At step 2, the UE is moved to a new cell/TA where the S-NSSAI-A is not supported/allowed as per partially allowed NSSAI list or S-NSSAI location availability information or NS-AoS information. At step 3, the UE initiating a NAS transport message to send CIoT user data container of the PDU of the PDU session of S-NSSAI-A at Radio Access Network (RAN).

At step 4, the AMF may accept/reject the uplink (UL) NAS transport message, when the UE is in an area (TAI/cell) where respective S-NSSAI is not supported based on partially/partly allowed NSSAI list or S-NSSAI location availability information.

Therefore, known mobility management signaling messages are allowed, but whether UE can use this signaling message to send control plane data to network has not described.

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate, the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration”. Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third, etc., to describe components/elements/steps is for the purposes of this description and should not be construed as sequential ordering/placement/occurrence unless specified otherwise.

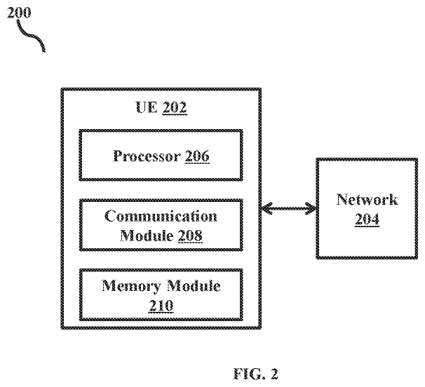

Embodiments provide systems and methods to block control plane data for partially allowed NSSAI and NS-AoS when a UE is in an area/cell/TA where the S-NSSAI (e.g., S-NSSAI-A) is not available/supported. Referring now to the drawings, and more particularly to FIGS. 2 through 10, where similar reference characters denote corresponding features consistently throughout the figures, there are shown embodiments.

FIG. 2 is a diagram illustrating a system for managing CP data for partially allowed NSSAI and a NS-AoS, according to an embodiment. A system 200 includes a UE 202 and a network 204. The UE 202 includes a processor 206, a communication module 208, and a memory module 210.

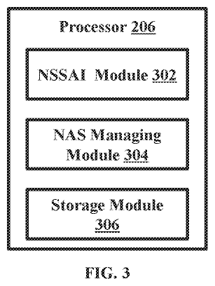

In an embodiment, the processor 206 is coupled with the memory module 210 and configured to manage the CP data of at least one cell based on a partially allowed NSSAI list and NS-AoS information. The processor 206 includes a NSSAI module 302, a NAS managing module 304, and a storage module 306, as depicted in FIG. 3.

In an embodiment, the NSSAI module 302 may receive at least one of a partially allowed NSSAI list, and NS-AoS information from the network 204. The partially allowed NSSAI list may indicate one or more TAIs, where at least one S-NSSAI is supported or not supported. The NS-AoS information may indicate one or more cells where the S-NSSAI is supported or not supported. In an embodiment, the NSSAI module 302 may receive an updated configuration of at least one of the partially allowed NSSAI list and the NS-AoS information from the network 204 through a downlink (DL) NAS message, after receiving a reject response from the network 204.

In an embodiment, the NAS managing module 304 may identify if a desired S-NSSAI (e.g., S-NSSAI-A) on a current cell and/or a current TAI is supported, based on at least one of the partially allowed NSSAI list and the NS-AoS information. The NAS managing module 304 may decide on initiating an UL NAS message to the network 204, on identifying whether the S-NSSAI-A of the current cell or the current TAI is supported. The UL NAS message is used for sending the CP data over the current cell or the current TAI to the network 204.

In an embodiment, the current TAI is one of a current camped TAI and a selected TAI. The current cell is one of a current camped cell and a selected cell.

In an embodiment, the NAS managing module 304 may bar/refrain/restrict from sending the UL NAS message for sending the CP data over the current cell or the current TAI to the network 204, upon identifying that the S-NSSAI-A is not supported. The NAS managing module 304 may identify that the S-NSSAI-A of the cell is not supported on the current cell or the current TAI, based on at least one of the partially allowed NSSAI list, and the NS-AoS information. The NAS managing module 304 may initiate the UL NAS message for sending the CP data over the current cell to the network 204, upon identifying that the S-NSSAI-A on the current cell is supported. The NAS managing module 304 may identify that the S-NSSAI-A on the current cell is supported, based on the NS-AoS information. The NAS managing module 304 may initiate the UL NAS message for sending the CP data over the current TAI to the network 204, upon identifying that the S-NSSAI-A on the current TAI is supported. The NAS managing module 304 may identify that the S-NSSAI-A on the current TAI is supported, based on the partially allowed NSSAI list.

In an embodiment, the NAS managing module 304 may initiate the UL NAS message for sending the CP data over the current cell to the network 204, upon identifying that the S-NSSAI-A on the current cell is supported, based on the NS-AoS information, and the S-NSSAI-A is not supported on the current TAI, based on the partially allowed NSSAI list. The NAS managing module 304 may initiate the UL NAS message for sending the CP data over the current TAI to the network 204, upon identifying that the S-NSSAI-A on the current TAI is supported, based on the partially allowed NSSAI list, and the S-NSSAI-A is not supported on the current cell, based on the NS-AoS information.

In an embodiment, the NAS managing module 304 may bar/refrain/restrict the UL NAS message from sending the CP data over the current cell to the network 204, upon identifying that the S-NSSAI-A on the current cell is not supported, based on the NS-AoS, and the S-NSSAI-A is supported on the current TAI, based on the partially allowed NSSAI list. The NAS managing module 304 may bar/refrain/restrict the UL NAS message from sending the CP data over the current TAI to the network 204, upon identifying that the S-NSSAI-A on the current TAI is not supported, based on the partially allowed NSSAI list, and the S-NSSAI-A is supported on the current cell, based on the NS-AoS information.

In an embodiment, the NAS managing module 304 may terminate sending of the CP data of the current cell, upon receiving the reject response from the network 204.

In an embodiment, the storage module 306 may store the current cell as not supported for the S-NSSAI-A, upon receiving the reject response from the network 204.

In an embodiment, the network 204 includes a processor and a memory module. The processor is coupled with the memory module. The network 204 may be at least one of a session management function (SMF) and an AMF. The processor of the network 204 may send a partially allowed NSSAI list and NS-AoS information to the UE 202. The partially allowed NSSAI list may indicate one or more TAIs where at least one S-NSSAI is supported or not supported, and the NS-AoS information may indicate one or more cells where the S-NSSAI is supported or not supported. The processor of the network 204 may bar from sending the CP data of at least one S-NSSAI to the UE 202 over a mobile terminated (MT) direction, based on a determination from at least one of a partially allowed NSSAI list and NS-AoS information that at least one of a current cell and a current TAI does not support the S-NSSAI. The processor of the network 204 may receive the UL NAS message from the UE 202 over a current cell and/or a current TAI, upon identifying by the UE 202 if a desired S-NSSAI (e.g., S-NSSAI-A) on the current cell or the current TAI is supported or not supported, based on at least one of the partially allowed NSSAI list and the NS-AoS information. The UL NAS message carries the CP data over the current cell or the current TAI. The processor of the network 204 may send a reject response to the UE 202 indicating that sending of the CP data on the current cell is not allowed/supported. The processor of the network 204 can send the reject response in response to the UL NAS transport message indicating that the UE 202 is on the current cell that does not support the S-NSSAI-A. The processor of the network 204 may send the DL NAS message to the UE 202 for allowing the UE 202 to send the CP data on the current cell. The processor of the network 204 may send the DL NAS message to the UE 202, after receiving the UL NAS transport message indicating that the UE 202 is on the current cell that does not support the S-NSSAI-A.

In an embodiment, the processor 206 may process and execute data of a plurality of modules of the UE 202. The processor 206 may be configured to execute instructions stored in the memory module 210. The processor 206 may include one or more of microprocessors, circuits, and other hardware configured for processing. The processor 206 may be at least one of a single processor, a plurality of processors, multiple homogeneous or heterogeneous cores, multiple central processing units (CPUs) of different kinds, microcontrollers, special media, and other accelerators. The processor 206 may be an application processor (AP), a graphics-only processing unit (e.g., a graphics processing unit (GPU), a visual processing unit (VPU)), and/or an artificial intelligence (AI)-dedicated processor (e.g., a neural processing unit (NPU)).

In an embodiment, the plurality of modules of the processor 206 of the UE 202 may communicate via the communication module 208. The communication module 208 may be in the form of either a wired network or a wireless communication network module. The wireless communication network may comprise, but is not limited to, global positioning system (GPS), global system for mobile communications (GSM), Wi-Fi, Bluetooth low energy, near-field communication (NFC), and so on. The wireless communication may further comprise one or more of Bluetooth, ZigBee, a short-range wireless communication (e.g., ultra-wideband (UWB)), and a medium-range wireless communication (e.g., Wi-Fi) or a long-range wireless communication (e.g., 3G/4G/5G/6G and non-3GPP technologies or WiMAX), according to the usage environment.

In an embodiment, the memory module 210 may include one or more volatile and non-volatile memory components which are capable of storing data and instructions of the modules of the UE 202 to be executed. Examples of the memory module 210 may be, but are not limited to, NAND, embedded multi-media card (eMMC), secure digital (SD) cards, universal serial bus (USB), serial advanced technology attachment (SATA), and solid-state drive (SSD). The memory module 210 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 210 may, in some examples, be considered a non-transitory storage medium. The term “non-transitory” may indicate that the storage medium is not embodied in a carrier wave or a propagated signal. However, the term “non-transitory” should not be interpreted to mean that the memory module 210 is non-movable. In certain examples, a non-transitory storage medium may store data that can, over time, change (e.g., in random access memory (RAM) or cache).

FIG. 2 shows an example modules of the UE 202, but it is to be understood that other embodiments are not limited thereto. In other embodiments, the UE 202 may include fewer or more modules. Further, the labels or names of the modules are used only for illustrative purposes and do not limit the scope of the present invention. One or more modules may be combined together to perform the same or a substantially similar function in the UE 202.

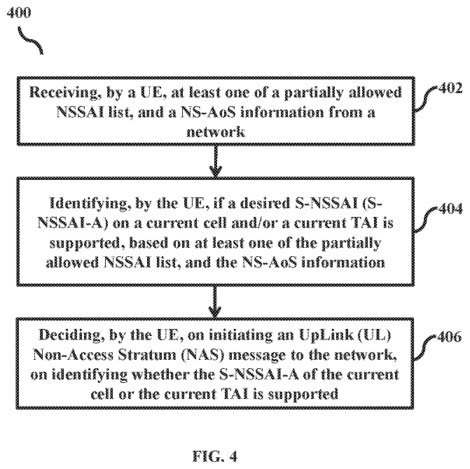

FIG. 4 is a diagram illustrating a method for managing the CP data for a partially allowed NSSAI and a NS-AoS, according to an embodiment. A method 400 includes receiving, by the processor 206 of the UE 202, at least one of a partially allowed NSSAI list and NS-AoS information from the network 204, as shown at 402. The partially allowed NSSAI list indicates one or more TAIs where at least one S-NSSAI is supported or not supported, and the NS-AoS information indicates one or more cells where at least one S-NSSAI is supported or not supported.

The method includes identifying, by the processor 206 of the UE 202, if a desired S-NSSAI (e.g., S-NSSAI-A) on a current cell and/or a current TAI is supported, based on at least one of the partially allowed NSSAI list and the NS-AOS information, as shown at 404. Thereafter, the method 400 includes deciding, by the processor 206 of the UE 202, on initiating an UL NAS message to the network 204, upon identifying whether the S-NSSAI-A of the current cell or the current TAI is supported, as shown at 406. The UL NAS message is used for sending the CP data over the current cell or the current TAI to the network 204.

The various steps of the method 400 may be performed in the order presented, in a different order, or simultaneously. Further, some steps listed in the method 400 of FIG. 4 may be omitted.

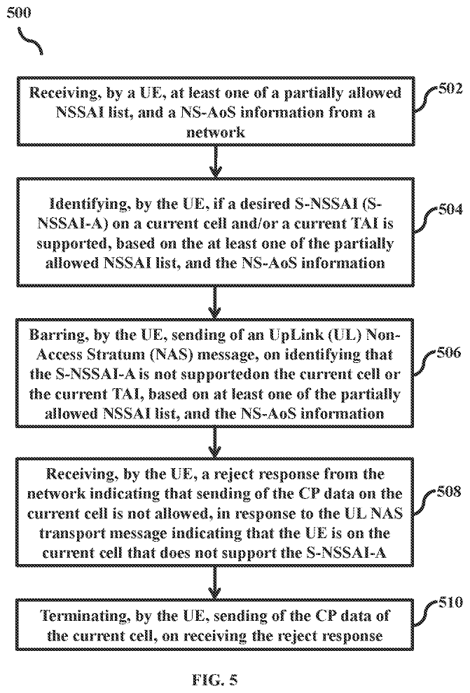

FIG. 5 is a diagram illustrating a method for managing the CP data for a partially allowed NSSAI and a NS-AoS when the S-NSSAI-A of at least one cell/TAI is not supported, according to an embodiment. The method 500 includes receiving, by the UE 202, at least one of a partially allowed NSSAI list and NS-AoS information from the network 204, as shown at 502. The partially allowed NSSAI list may indicate one or more TAIs where at least one S-NSSAI is supported or not supported, and the NS-AoS information may indicate one or more cells where at least one S-NSSAI is supported or not supported.

The method 500 includes identifying, by the UE 202, if a desired S-NSSAI (e.g., S-NSSAI-A) on a current cell and/or a current TAI is supported, based on at least one of the partially allowed NSSAI list and the NS-AoS information, as shown at 504. The method 500 includes barring, by the UE 202, sending of an UL NAS message, upon identifying that the S-NSSAI-A is not supported on the current cell and/or the current TAI, as shown at 506, based on at least one of the partially allowed NSSAI list and the NS-AoS information.

The method 500 includes receiving, by the UE 202, a reject response from the network 204 indicating that sending of the CP data on the current cell is not allowed, as shown at 508, in response to the UL NAS transport message. The UL NAS transport message indicates that the UE 202 is on the current cell that does not support the S-NSSAI-A. The method 500 includes terminating, by the UE 202, sending of the CP data of the current cell, upon receiving the reject response, as shown at 510.

The various steps in the method 500 may be performed in the order presented, in a different order, or simultaneously. Further, some steps in the method 500 of FIG. 5 may be omitted.

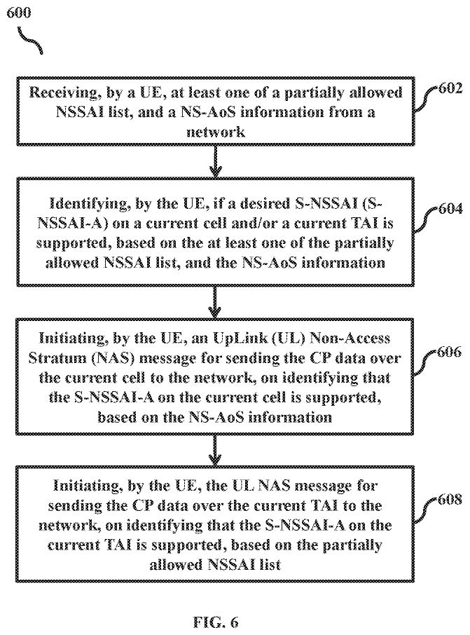

FIG. 6 is a diagram illustrating a method for managing the CP data for a partially allowed NSSAI and a NS-AoS when the S-NSSAI-A of at least one cell is not supported, according to another embodiment. The method 600 includes receiving, by the UE 202, at least one of a partially allowed NSSAI list and NS-AoS information from the network 204, as shown at 602. The method 600 includes identifying, by the UE 202, if a desired S-NSSAI (e.g., S-NSSAI-A) on a current cell and/or a current TAI is supported, based on at least one of the partially allowed NSSAI list, and the NS-AoS information, as shown at 604.

The method 600 includes initiating, by the UE 202, an UL NAS message for sending the CP data over the current cell to the network 204, upon identifying that the S-NSSAI-A on the current cell is supported, as shown at 606, based on the NS-AoS information. The method 600 includes initiating, by the UE 202, the UL NAS message for sending the CP data over the current TAI to the network 204, upon identifying that the S-NSSAI-A on the current TAI is supported, as shown at 608, based on the partially allowed NSSAI list.

The various steps in the method 600 may be performed in the order presented, in a different order, or simultaneously. Further, some steps listed in the method 600 of FIG. 6 may be omitted.

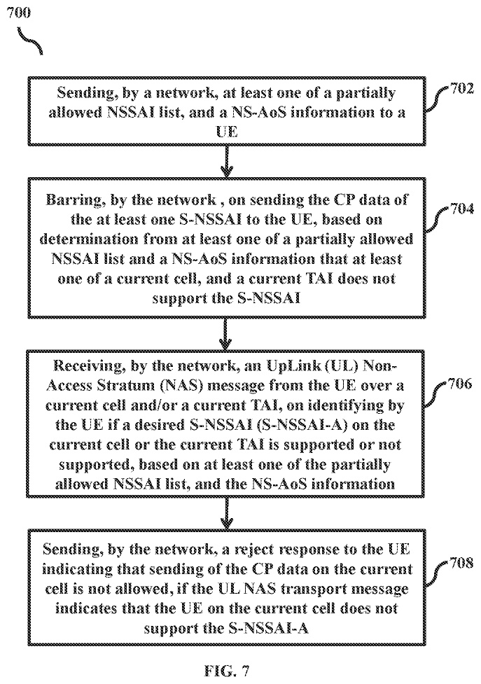

FIG. 7 is a diagram illustrating a method for managing the CP data by the network 204 for a partially allowed NSSAI and a NS-AoS, according to an embodiment. A method 700 includes sending, by the network 204, at least one of a partially allowed NSSAI list and NS-AoS information to the UE 202, as shown at 702. The partially allowed NSSAI list may indicate one or more TAIs where at least one S-NSSAI is supported or not supported, and the NS-AoS information may indicate one or more cells where the S-NSSAI is supported or not supported. The method 700 includes barring, by the network 204, on sending the CP data of at least one S-NSSAI to the UE 202, as shown at 704, over an MT direction, based on a determination from at least one of a partially allowed NSSAI list and NS-AOS information that at least one of a current cell and a current TAI does not support the S-NSSAI.

The method 700 includes receiving, by the network 204, the UL NAS message from the UE 202 over a current cell and/or a current TAI, as shown at 706, upon identifying by the UE 202 if a desired S-NSSAI (e.g., S-NSSAI-A) on the current cell or the current TAI is supported or not supported, based on at least one of the partially allowed NSSAI list and the NS-AoS information. The UL NAS message carries the CP data over the current cell or the current TAI. The method 700 includes sending, by the network 204, a reject response to the UE 202, as shown at 708, indicating that sending of the CP data on the current cell is not allowed, if the UL NAS transport message indicates that the UE 202 on the current cell does not support the S-NSSAI-A.

The various steps in the method 700 may be performed in the order presented, in a different order, or simultaneously. Further, some steps listed in the method 700 of FIG. 7 may be omitted.

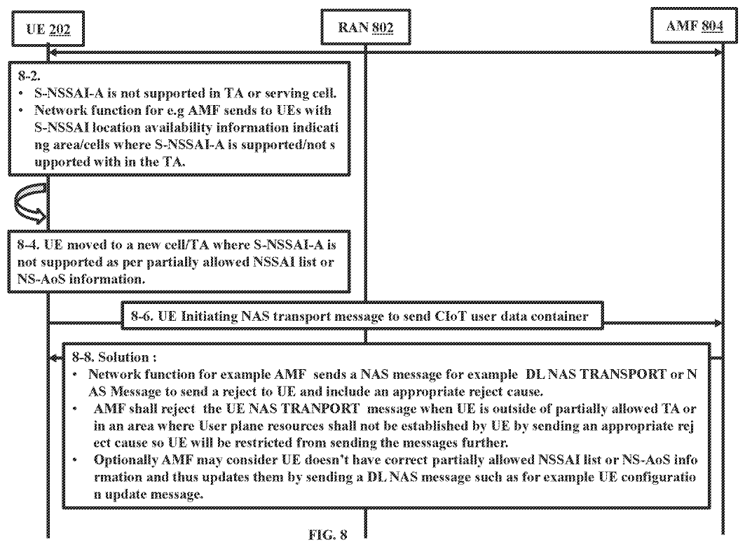

FIG. 8 is a diagram illustrating a message sequence diagram of a network rejecting a UE NAS transport with appropriate reject cause, according to an embodiment. At step 8-2, an S-NSSAI-A is not supported in TA or serving cell at the UE 202. A network function, for example, an AMF 804, sends to UEs with S-NSSAI location availability information indicating, partially allowed NSSAI or partially rejected NSSAI information indicating area/cells/TAI where S-NSSAI-A is supported/not supported within the TA. At step 8-4, the UE 202 is moved to a new cell/TA where S-NSSAI-A is not supported as per partially/partly allowed NSSAI list or NS-AoS information or S-NSSAI location availability information.

At step 8-6, the UE 202 initiating a NAS transport message at a RAN 802 is depicted to send CIOT user data container. At step 8-8, the network function, for example, the AMF 804, sends a NAS message, for example, downlink (DL) NAS transport or NAS message, to send a reject to the UE 202, and include an appropriate reject cause indicating in current TAI/cell sending CP data is not allowed. There can be a separate reject cause which helps the UE to identify that the current TAI is not allowed/supported or the current cell is not allowed/supported for the desired S-NSSAI. The UE 202 can include (memorize) the respective TA/cell as not supported for this S-NSSAI-A, and the UE 202 may not attempt to send the CP data in the respective TAI/cell for that S-NSSAI. However, when the UE 202 changes the TAI/cell, the UE 202 may attempt to send the CP data again based on partially/partly allowed NSSAI list/S-NSSAI location availability information or NS-AoS information.

Optionally, the AMF 804 may consider that the UE 202 doesn't have a correct partially/partly allowed NSSAI list, NS-AoS information, or S-NSSAI location availability information, and thus, updates them by sending a DL NAS message such as, for example, a UE configuration update message. The UE acts based on the newly received information.

If the request type IE is set to “initial request”, “existing PDU session”, “modification request”, or “MA PDU request”, optionally, if the UE 202 is not configured for high priority access in selected PLMN or SNPN, and the UE 202 is in TAI/cell which does not support the S-NSSAI-A, then the AMF 804 may send back a 5GSM message, to the UE 202, which was not forwarded and a 5GMM cause, for example, #28 “Restricted service area” or any other cause indicating this area (e.g., TAI/cell) or separate reject cause to indicate that the TAI or cell is not supported for this S-NSSAI-A. The UE 202 passes an indication to the 5GSM sublayer that the 5GSM message was not forwarded due to the UE 202 is in TAI/cell which does not support the S-NSSAI-A along with the 5GSM message from a payload container IE of the DL NAS transport message. Upon receiving an indication that the 5GSM message was not forwarded due to restrictions-NSSAI is not allowed along with a PDU SESSION ESTABLISHMENT REQUEST/5GSM message with the PDU session ID IE set to the same value as the PDU session ID that was sent by the UE 202, the UE 202 may stop the timer T3580 and abort the procedure.

Further, the UE 202 is restricted from sending the requests again until the UE 202 is moved to an area/cell/TAI where the S-NSSAI is supported or outside the current cell or TAI. If the reject cause indicates that TAI was not supported, the UE stores this information and does not attempt to send the NAS message with CP data on that TAI when UE moves out of that TAI, and the UE may attempt to send CP data again (if there is any pending data). If the reject cause indicates that the cell was not supported then the UE stores this information and does not attempt to send the NAS message with CP data on that cell when the UE moves out of that cell, the UE may attempt to send CP data again (if there is any pending data).

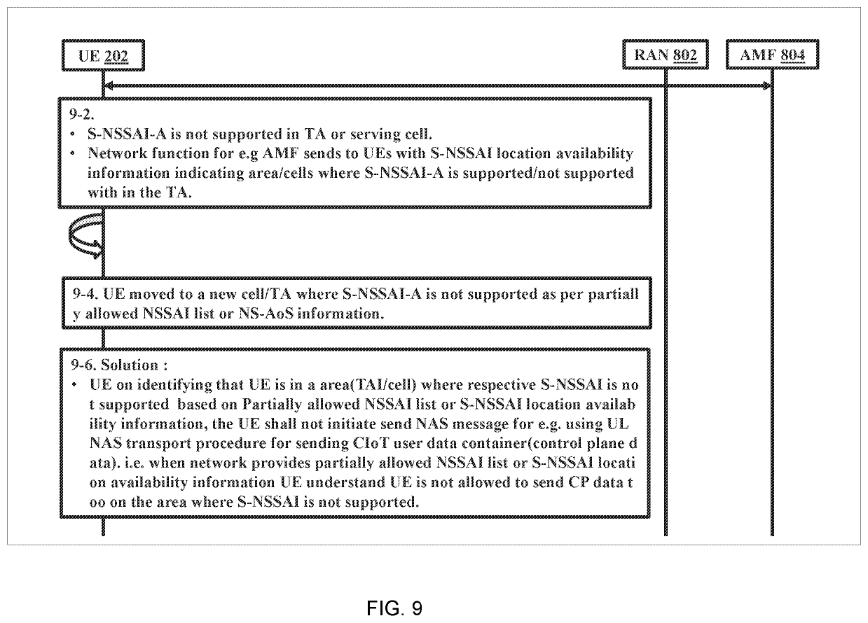

FIG. 9 is a diagram illustrating a message sequence diagram of a UE not initiating the NAS transport procedure for CIoT user data container when the UE is in an area/cell/TA where the S- NSSAI (for example, S-NSSAI-A) is not available/supported according to the NS-AoS area or S-NSSAI location availability information, according to an embodiment. At step 9-2, the S-NSSAI-A is not supported in the TA or serving cell. The network function, for example, the AMF 804, sends to UEs with S-NSSAI location availability information indicating area/cells where S-NSSAI-A is supported/not supported within the TA. At step 9-4, the UE 202 is moved to a new cell/TA where S-NSSAI-A is not supported as per partially/partly allowed NSSAI list or NS-AoS information or S-NSSAI location availability information.

At step 9-6, the UE 202, upon identifying that UE 202 is in an area (TAI/cell) where respective S-NSSAI is not supported based on partially/partly allowed NSSAI list or S-NSSAI location availability information, may not initiate to send the NAS message, for example, using UL NAS transport procedure for sending CIoT user data container (control plane data). For example, when the network 204 provides partially/partly allowed NSSAI list or S-NSSAI location availability information, the UE 202 understands that the UE 202 is not allowed to send CP data on the area where S-NSSAI is not supported, and further requests for user plane resources are not allowed or restricted for the UE 202. Similarly, on the network side (i.e., network function), for example, by SMF/AMF shall not send the control plane (CP) data belonging to the PDU session of the S-NSSAI to the UE (i.e., data in DL/MT direction) based on the determination from the partially allowed NSSAI list or NS-AoS that current cell and/or current TAI does not support the respective S-NSSAI. The UE and SMF may not exchange user data as a payload of a NAS message in both UL and DL directions in the area where the S-NSSAI is not supported/not allowed/rejected. The UE and SMF may exchange user data as a payload of a NAS message in both UL and DL directions in the area where the S-NSSAI is supported/allowed/not rejected. The SMF determines the area UE belongs to with the information received from the AMF. The network function (AMF or SMF) after blocking the CP data may indicate to another network function (e.g., user plane function (UPF)/network exposure function (NEF)) which sent the CP data to AMF/SMF that the CP data cannot be sent to the UE and the UE is unreachable for this PDU session.

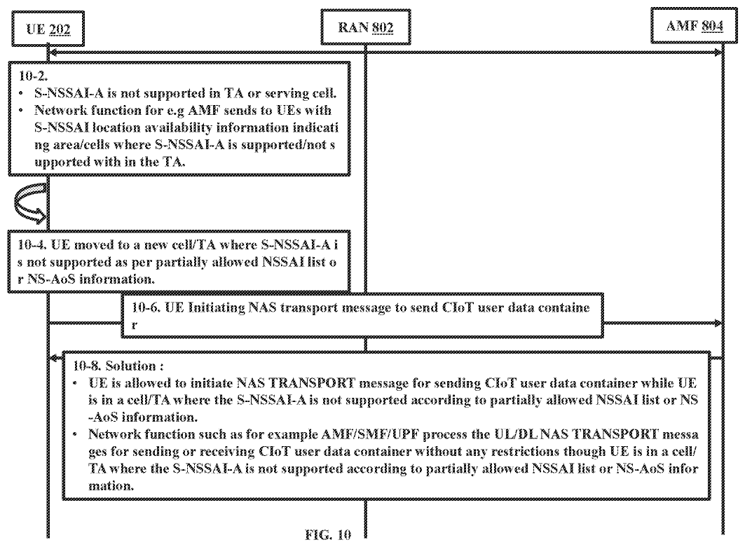

FIG. 10 is a diagram illustrating a message sequence diagram where a UE is allowed to initiate the NAS transport procedure for CIoT user data container when the UE is in an area/cell/TA where the S-NSSAI (e.g., S-NSSAI-A) is not available/supported according to NS-AoS area or S-NSSAI location availability information, according to an embodiment. As shown at step 10-2, the S-NSSAI-A is not supported in the TA or serving cell. The network function, for example, the AMF 804, sends to UEs with S-NSSAI location availability information indicating area/cells where S-NSSAI-A is supported/not supported within the TA. At step 10-4, the UE 202 moves to a new cell/TA where S-NSSAI-A is not supported as per partially allowed NSSAI list or NS-AoS information or S-NSSAI location availability information. At step 10-6, the UE 202 initiates a NAS transport message to send CIoT user data container at RAN 802.

At step 10-8, the UE 202 is allowed to initiate a NAS transport message for sending a CIoT user data container while the UE 202 is in a cell/TA where the S-NSSAI-A is not supported according to partially allowed NSSAI list or NS-AoS information or S-NSSAI location availability information. The network function such as, for example, AMF/SMF/UPF processes the UL/DL NAS transport messages for sending or receiving CIoT user data container without any restrictions though the UE 202 is in a cell/TA where the S-NSSAI-A is not supported according to partially allowed NSSAI list, NS-AoS information, or S-NSSAI location availability information. Further, only user plane resource establishment is restricted.

In an embodiment, the UE 202 may switch from a user plane (UP) PDU session to a CP PDU session to send the data in an area (TAI/cell) where S-NSSAI is not supported based on partially allowed NSSAI list or S-NSSAI location availability information.

The terms S-NSSAI location availability information, NS-AoS, and partially allowed NSSAI or partially rejected NSSAI may be used interchangeably to indicate whether a S-NSSAI is supported/allowed or NOT supported/not allowed in the area indicated by them. Based on this determination, the UE and network actions in the respective area are described in this embodiment. The area can be any unit like TAI, cell, set of TAI(s), set of cells(s), CAG cells etc.

The UL NAS message to send the CP data (i.e., control plane data) may be an UL NAS TRANSPORT message.

The term CP data or control plane data or CIoT user data or control plane user data or control plane data sent using control plane CIoT 5GS optimization may be used interchangeably and have same meaning to indicate control plane user data sent using the NAS signaling message using the signaling bearer and no user plane resources are established for this.

The terms support, allowed, and not rejected may be used interchangeably and have same meaning. The terms not supported, not allowed, and rejected may be used interchangeably and have same meaning.

The terms camped cell, serving cell, and selected cell may be used interchangeably and have the same meaning. Similarly, the terms camped TAI, serving TAI, and selected TAI are used interchangeably and have the same meaning.

The terms barring, refraining, blocking, or not send are used interchangeably and have the same meaning. The terms represent that a sending entity, though there is trigger to send the CP data, will not send but rather block/not send it at the sender entity.

In an embodiment, the UE 202 may switch from the CP PDU session to the UP PDU session (i.e., the UE 202 may request for user plane resources using uplink data status IE in a NAS message like service request/registration request message) to send the data in an area (TAI/cell) where S-NSSAI is supported based on partially allowed NSSAI list or S-NSSAI location availability information.

The embodiments may be implemented through at least one software program running on at least one hardware device and performing network management functions to control the network elements. The modules shown in FIG. 2 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

What is claimed is:

1. A method performed by a user equipment (UE) in a wireless communication system, the method comprising:
receiving, from an access management function (AMF) entity, a location availability information associated with single-network slice selection assistance information (S-NSSAI) indicating at least one cell of a tracking area (TA) where the S-NSSAI is available;
identifying whether the UE is located in the at least one cell of the TA where the S-NSSAI is available, based on the location availability information associated with the S-NSSAI; and
in case that the location of the UE is outside of the at least one cell of the TA, determining not to send a non access stratum (NAS) message for a user data.

2. The method of claim 1, further comprising:
receiving, from the AMF, network slice area of service (NS-AoS) information indicating the at least one cell of the TA.

3. The method of claim 1, further comprising:
receiving, from the AMF, partially allowed NSSAI list indicating the at least one cell of the TA.

4. The method of claim 1, further comprising:
receiving, from the AMF, a reject message indicating that a sending of the user data is not allowed.

5. A method performed by an access management function (AMF) in a wireless communication system, the method comprising:
transmitting, to a user equipment (UE), a location information associated with single-network slice selection assistance information (S-NSSAI) indicating at least one cell of a tracking area (TA) including a first cell supporting the S-NSSAI in the TA and a second cell not supporting the S-NSSAI in the TA;
wherein a location of the UE is identified, based on the location information associated with the S-NSSAI, and
wherein in case that the location of the UE is inside the second cell, not to send a non access stratum (NAS) message for a user data is determined.

6. The method of claim 5, further comprising:
transmitting, to the UE, network slice area of service (NS-AoS) information indicating the at least one cell of the TA.

7. The method of claim 5, further comprising:
transmitting, to the UE, partially allowed NSSAI list indicating the at least one cell of the TA.

8. The method of claim 5, further comprising:
transmitting, to the UE, a reject message indicating that a sending of the user data is not allowed.

9. A user equipment (UE) in a wireless communication system, the UE comprising:
a transceiver; and
a controller coupled with the transceiver configured to:
receive, from an access management function (AMF) entity, a location information associated with single-network slice selection assistance information (S-NSSAI) indicating at least one cell of a tracking area (TA) including a first cell supporting the S-NSSAI in the TA and a second cell not supporting the S-NSSAI in the TA,
identify a location of the UE, based on the location information associated with the S-NSSAI; and
in case that the location of the UE is inside the second cell, determine not to send a non access stratum (NAS) message for a user data.

10. The UE of claim 9, wherein the controller is further configured to:
receive, from the AMF, network slice area of service (NS-AoS) information indicating the at least one cell of the TA.

11. The UE of claim 9, wherein the controller is further configured to:
receive, from the AMF, partially allowed NSSAI list indicating the at least one cell of the TA.

12. The UE of claim 9, wherein the controller is further configured to:
receive, from the AMF, a reject message indicating that a sending of the user data is not allowed.

13. An access management function (AMF) in a wireless communication system, the AMF comprising:
a transceiver; and
a controller coupled with the transceiver configured to:
transmit, to a user equipment (UE), a location information associated with single-network slice selection assistance information (S-NSSAI) indicating at least one cell of a tracking area (TA) including a first cell supporting the S-NSSAI in the TA and a second cell not supporting the S-NSSAI in the TA,
wherein a location of the UE is identified, based on the location information associated with the S-NSSAI, and
wherein in case that the location of the UE is inside the second cell, not to send a non access stratum (NAS) message for a user data is determined.

14. The AMF of claim 13, wherein the controller is further configured to:
transmit, to the UE, network slice area of service (NS-AoS) information indicating the at least one cell of the TA.

15. The AMF of claim 13, wherein the controller is further configured to:
transmit, to the UE, partially allowed NSSAI list indicating the at least one cell of the TA, and
transmit, to the UE. a reject message indicating that a sending of the user data is not allowed.
